(19) United States
(12) Patent Application Publication
(10) Pub. No.: US 2013/0255728 A1
(43) Pub. Date: Oct. 3, 2013

(54) APPARATUS AND METHOD TREATING SUBSTRATE

(71) Applicant: SEMES CO., LTD., Cheonan-si (KR)

(72) Inventor: Hwan Ik NOH, Cheonan-si (KR)

(73) Assignee: SEMES CO., LTD., Cheonan-si (KR)

(21) Appl. No.: 13/851,351

(22) Filed: Mar. 27, 2013

(30) Foreign Application Priority Data
Mar. 28, 2012 (KR) 10-2012-0031889

(51) Int. Cl. B05B 13/02

(52) U.S. Cl. CPC B05B 13/02
USPC 134/26; 134/103.2

(57) ABSTRACT

A substrate treating apparatus is provided which includes a housing which provides a space in which a process is performed; a spin head which supports and rotates a substrate; and a spray unit which sprays a fluid on the substrate. The spray unit comprises a first nozzle mistily spraying a first fluid; and second nozzle spraying a second fluid.

### CROSS-REFERENCE TO RELATED APPLICATIONS

A claim for priority under 35 U.S.C. §119 is made to Korean Patent Application No. 10-2012-0031889 filed Mar. 28, 2012, in the Korean Intellectual Property Office, the entire contents of which are hereby incorporated by reference.

### BACKGROUND

The inventive concepts described herein relate to a method and apparatus for treating a substrate, and more particularly, relate to a method and apparatus treating a substrate to spray a solution.

Various processes such as lithography, etching, ashing, ion implantation, thin film deposition, and so on may be applied to a substrate to fabricate a semiconductor device or a liquid crystal display. A substrate cleaning process may be carried out before or after each process to remove particles and contaminants generated at each process.

In general, ways for spraying a solution on a substrate through a nozzle at a cleaning process may include a mist way and a dropping way. The mist way may be divided into a two-fluid way and a minute discharge hole way. In the two-fluid way, a solution may be sprayed to a small particle by spraying an inactive gas directly to a discharged solution. In the minute discharge hole way, a fluid may be sprayed to a small particle through a scaled-down discharge hole. The dropping way may be such a way that a fluid is directly supplied to a substrate without processing. The mist way may be advantageous to reduce an adhesive force of contaminants and particles attached on a substrate. The dropping way may be advantageous to remove contaminants and particles the adhesive force of which is reduced. However, a general cleaning apparatus may be configured to supply a fluid to a substrate using only one way of the mist way and the dropping way. In this case, since a cleaning process is carried out using one merit, a cleaning efficiency may be lowered.

Two nozzles for spraying different solutions according to a device may be installed at a support arm. In general, the closer a distance between a nozzle and a substrate, the higher a removal efficiency of contaminants and particles. On the other hand, since a fluid is spattered from a substrate, a cleaning apparatus may be contaminated. However, in a general apparatus, discharge stages of two nozzles may be placed at the same height regardless of a sort of fluid or a fluid spraying way. In this case, a fluid of one of the two nozzles may contaminate the other nozzle.

### SUMMARY

One aspect of embodiments of the inventive concept is directed to provide a substrate treating apparatus which comprises a housing which provides a space in which a process is performed; a spin head which supports and rotates a substrate; and a spray unit which sprays a fluid on the substrate. The spray unit comprises a first nozzle mistily spraying a first fluid; and second nozzle spraying a second fluid.

The first nozzle sprays the first fluid in a two-fluid way. The first nozzle sprays the first fluid in a minute discharge hole way. The second nozzle mistily sprays the second fluid. The first nozzle and the second nozzle spray a fluid in a two-fluid way. The spray unit further comprises a first gas line which supplies a gas to the first nozzle and has a first flow adjusting member; a second gas line which supplies a gas to the second nozzle and has a second flow adjusting member; and a controller which controls the first flow adjusting member and the second flow adjusting member. The controller controls the first flow adjusting member and the second flow adjusting member so that a size of mist sprayed from the first nozzle is different from that of mist sprayed from the second nozzle. The first nozzle and the second nozzle spray a fluid in a minute discharge hole way. A size of a discharge hole of the first nozzle is different from that of the second nozzle so that a size of mist sprayed from the first nozzle is different from that of mist sprayed from the second nozzle. The substrate treating apparatus further comprises a first flow adjusting member which adjusts a flow of the first fluid; a second flow adjusting member which adjust a flow of the second fluid; and a controller which controls the first flow adjusting member and the second flow adjusting member. The controller controls the first flow adjusting member and the second flow adjusting member so that a size of mist sprayed from the first nozzle is different from that of mist sprayed from the second nozzle. One of the first nozzle and the second nozzle sprays a fluid in a two-fluid way and the other sprays a fluid in a minute discharge hole way. The second nozzle sprays the second fluid in a dropping way.

The substrate treating apparatus further comprises a nozzle support member which supports the first nozzle and the second nozzle. The nozzle support member comprises a vertical shaft the length direction of which is provided in an up-and-down way; and a support bar which is extended from the vertical shaft in a lateral direction and is coupled with the first nozzle and the second nozzle. The nozzle support member further comprises a height adjusting member which adjusts relative heights of the first nozzle and the second nozzle. The substrate treating apparatus further comprises a first nozzle support member which supports the first nozzle; and a second nozzle support member which supports the second nozzle, wherein the first nozzle support member comprises a first vertical shaft the length direction of which is provided in an up-and-down direction; and a first support bar which is extended from the first vertical shaft and is coupled with the first nozzle, and wherein the second nozzle support member comprises a second vertical shaft the length direction of which is provided in an up-and-down direction; and a second support bar which is extended from the second vertical shaft and is coupled with the second nozzle. The substrate treating apparatus further comprises a nozzle support member which supports the first nozzle and the second nozzle, wherein the nozzle support member comprises a vertical shaft the length direction of which is provided in an up-and-down direction; a first support bar which is extended from the vertical shaft and is coupled with the first nozzle; and a second support bar which is extended from the vertical shaft and is coupled with the second nozzle, and wherein the first support bar makes an acute angle with the second support bar when viewed from an upper side. The spray unit further comprises a rotation driver which rotates the vertical shaft with an up-and-down direction as the center. A height of the first support bar is different from a height of the second support bar. The substrate treating apparatus further comprising a height adjusting member which adjusts relative heights of the first and second support bars. A first path for supplying the first fluid is provided within the first nozzle and a second path is provided within the second nozzle, one of the first and second paths surrounding the other. The spray unit further comprises a first fluid line which supplies the first fluid to the first nozzle; and a second fluid line which supplies the second fluid to the second nozzle, the second fluid line being branched from the first fluid line.

A method of treating a substrate using a first nozzle and a second nozzle, the first nozzle spraying a first fluid on the substrate, the second nozzle spraying a second fluid on the substrate, and the first nozzle mistily spraying the first fluid.

The second nozzle mistily sprays the second fluid and the first nozzle and the second nozzle spray a fluid in a two-fluid way. The second nozzle mistily sprays the second fluid and the first nozzle and the second nozzle spray a fluid in a minute discharge hole way. The second nozzle mistily sprays the second fluid and the first nozzle, one of the first and second nozzles sprays a fluid in a two-fluid way, and the other sprays a fluid in a minute discharge hole way. The first and second fluids are the same fluid. Relative heights of the first and second nozzles are adjusted so that a first area of the substrate on which the first fluid is supplied and a second area of the substrate on which the second fluid is supplied have different from each other.

With embodiments of the inventive concept, it is possible to improve an efficiency of a substrate cleaning process. Also, since a first nozzle and a second nozzle spray a fluid in different ways, it is possible to reduce an adhesive force of contaminants on a substrate and to remove contaminants efficiently. Further, since the first nozzle and the second nozzle spray mist in different ways, it is possible to improve an efficiency of a substrate cleaning process. A rate of removal on contaminants and particles attached on the substrate may be improved by controlling mist sizes of the first and second nozzles differently and by adjusting distances between the first and second nozzles and the substrate. Still further, it is possible to minimize contamination of a cleaning apparatus by a sprayed fluid spattered from the substrate.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a plan view of a substrate treating apparatus I according to an embodiment of the inventive concept.

FIG. 2 is a sectional view of a substrate treating apparatus 300 of FIG. 1.

FIG. 3 is a perspective view of a spray unit of FIG. 2 according to an embodiment of the inventive concept.

FIG. 4 is a sectional view of a first nozzle of FIG. 3 according to an embodiment of the inventive concept.

FIG. 5 is a diagram schematically illustrating lines for supplying fluids to a first nozzle and a second nozzle according to an embodiment of the inventive concept.

FIG. 6 is a diagram schematically illustrating lines for supplying fluids to a first nozzle and a second nozzle according to another embodiment of the inventive concept.

FIGS. 7 to 16 are views of a spray unit of FIG. 2 according to other embodiments of the inventive concept.

FIG. 17 is a plan view of areas on which first and second fluids are sprayed through a nozzle of FIG. 16.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

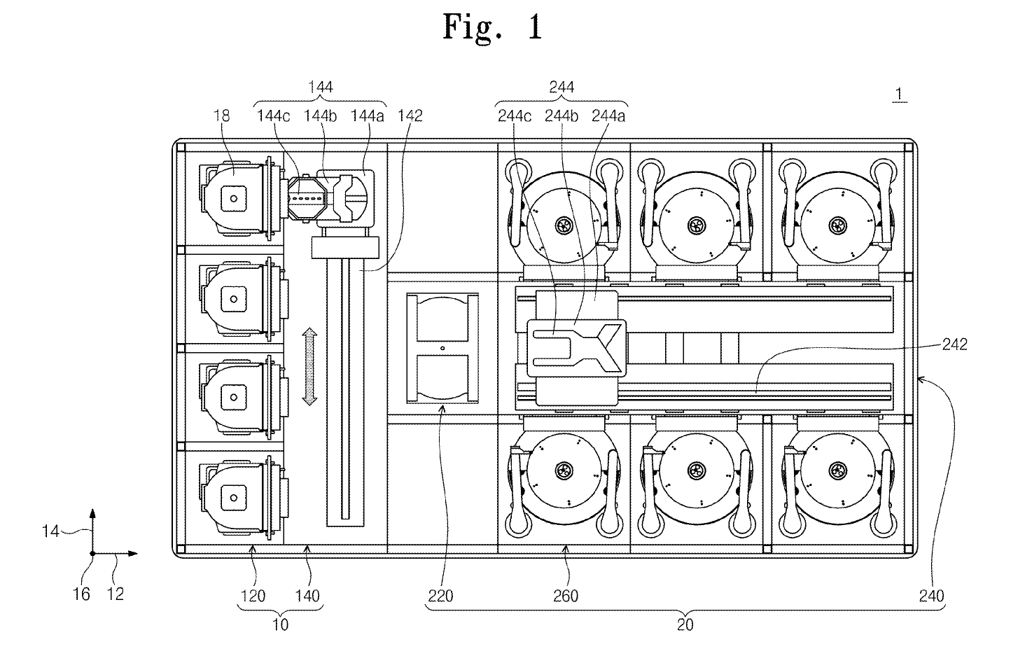

FIG. 1 is a plan view of a substrate treating apparatus 1 according to an embodiment of the inventive concept. Referring to FIG. 1, a substrate treating apparatus 1 may include an index module 10 and a process treating module 20. The index module 10 may have a load port 120 and a transfer frame 140. The load port 120, the transfer frame 140, and the process treating module 20 may be sequentially arranged in a line. Below, a direction in which the load port 120, the transfer frame 140, and the process treating module 20 are arranged may be referred to as a first direction 12. When viewed from the upper side, a direction perpendicular to the first direction 12 may be referred to as a second direction 14, and a direction perpendicular to the first and second directions 12 and 14 may be referred to as a third direction 16.

A carrier 130 in which a substrate is received may be disposed on the load port 140. When the load port 140 is provided in plurality, the load ports 120 may be disposed in a line along the second direction 14. The number of load ports 120 may increase or decrease according to process efficiency and a foot print of the process treating module 20. A plurality of slots (not shown) may be formed at the carrier 130 such that substrates are received at a state where they are disposed to be horizontal with respect to a ground. A front open unified pod (FOUP) may be used as the carrier 130.

The process treating module 20 may include a buffer unit 220, a transfer chamber 240, and process chambers 260. The transfer chamber 240 may be disposed such that a length direction of the transfer chamber 240 is parallel with the second direction 12. The process chambers 260 may be disposed at both sides of the transfer chamber 240. The process chambers 260 may be disposed to be symmetrical at one side and the other side of the transfer chamber 240 on the basis of the transfer chamber 240. A plurality of process chambers 260 may be provided at one side of the transfer chamber 240. A part of the process chambers 260 may be disposed along a length direction of the transfer chamber 240. A part of the process chambers 260 may be disposed to be stacked one another. That is, the process chambers 260 may be disposed at one side of the transfer chamber 240 in a “A×B” matrix. Herein, “A” may indicate the number of process chambers 260 disposed in a line along the first direction 12, and “B” may indicate the number of process chambers 260 disposed in a line along the third direction 16.

In the event that four or six process chambers 260 are provided at one side of the transfer chamber 240, the process chambers 260 may be disposed in a “2×2” or “3×2” matrix. The number of the process chambers 260 may increase or decrease. Unlike the above description, the process chambers 260 can be provided at one side of the transfer chamber 240. Also, the process chambers 260 may be provided at both sides or one side of the transfer chamber 240 in a single layer.

The buffer unit 220 may be disposed between the transfer frame 140 and the transfer chamber 240. The buffer unit 220 may provide a space in which the substrate W stays before it is transferred between the transfer frame 140 and the transfer chamber 240. A slot (not shown) on which the substrate is seated may be provided within the buffer unit 220. A plurality of slots (not shown) may be provided to be spaced apart from each other along the third direction 16. Surfaces of the buffer unit 220 opposite to the transfer frame 140 and the transfer chamber 240 may be opened.

The transfer frame 140 may transfer the substrate W between the carrier 130 seated on the load port 120 and the buffer unit 220. The transfer frame 140 may include an index rail 142 and an index robot 144. The index rail 142 may be disposed so that its length direction is parallel with the second direction 14. The index robot 144 may be installed on the index rail 142, and may rectilinearly move in the second direction 14 along the index rail 142. The index robot 144 may include a base 144a, a body 144b, and an index arm 144c. The base 144a may be disposed to move along the index rail 142. The body 144b may be coupled to the base 144a. The body 144b may be disposed to move along the third direction 16 on the base 144a. The body 144b may be provided to rotate on the base 144a. The index arm 144c may be coupled to the body 144b, and may be moved forward and backward. If the index arm 144c is provided in plurality, the index arms 144c may be independently operated. The index arms 144c may be spaced apart from each other along the third direction 16 and stacked. A part of the index arms 144c may be used when the substrate W is transferred from the process treating module 20 to the carrier 130, and a part of the remaining index arms 144c may be used when the substrate W is transferred from the carrier 130 to the process treating module 20. This may be to prevent particles generated from the substrate W before processing from being attached to the substrate W after processing.

The transfer chamber 240 may transfer the substrate W between the buffer unit 220 and the process chamber 260 and between the process chambers 260. The transfer chamber 240 may include a guide rail 242 and a main robot 244. The guide rail 242 may be disposed so that its length direction is parallel to the first direction 12. The main robot 244 may be installed on the guide rail 242, and may rectilinearly move along the first direction 12 on the guide rail 242. The main robot 244 may include a base 244a, a body 244b, and a main arm 244c. The base 244a may be installed to be moved along the guide rail 242. The body 244b may be coupled to the base 244a. The body 244b may be disposed to be moved along the third direction 16 on the base 244a. The body 244b may be provided to rotate on the base 244a. The main arm 244c may be coupled to the body 244b. This may enable the main arm 244c to be moved forward and backward with respect to the body 244b. If the main arm 244c is provided in plurality, the main arms 244c may be independently operated. The main arms 244c may be spaced apart from each other along the third direction 16 and stacked.

A substrate treating apparatus 300 performing a cleaning process on the substrate W may be provided within the process chamber 260. The substrate treating apparatus 300 may have different structures according to sorts of cleaning processes. On the other hand, the substrate treating apparatus 300 within each of the process chambers 260 may have the same structure. The process chambers 260 may be selectively divided into a plurality of groups. Structures of the substrate treating apparatuses 300 in process chambers 260 in the same group may be equal to each other, and structures of the substrate treating apparatuses 300 in process chambers 260 in different groups may be different from each other.

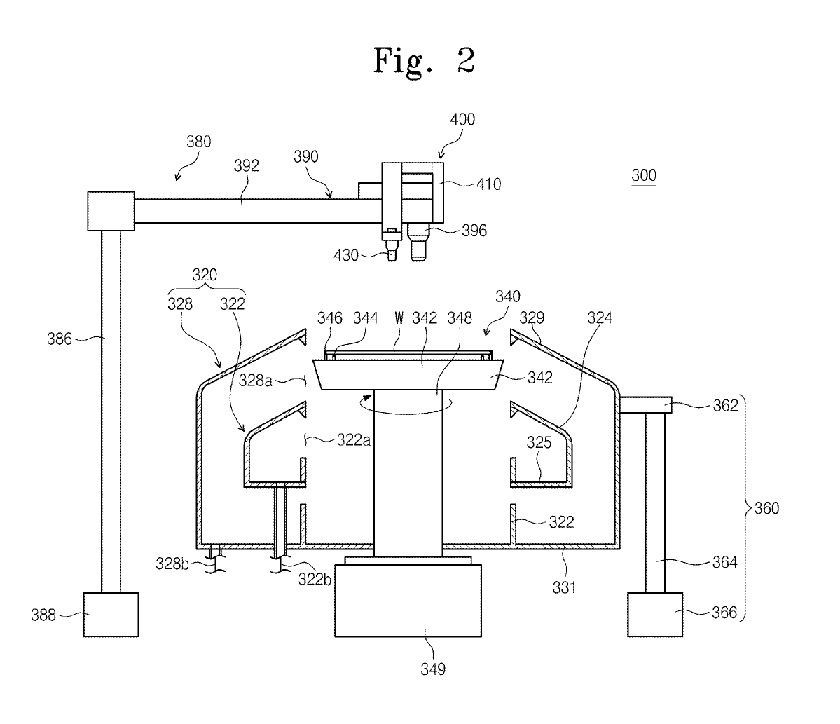

FIG. 2 is a sectional view of a substrate treating apparatus 300 of FIG. 1. Referring to FIG. 2, a substrate treating apparatus 300 may include a housing 320, a spin head 340, an elevation unit 360, a spray unit 380, and a cleaning member 400. The housing 320 may have a space in which a substrate treating process is performed, and an upper side thereof may be opened. The housing 320 may include an inner recovery container 322 and an outer recovery container 326. The inner recovery container 322 and the outer recovery container 326 may recover different fluids of fluids used at a process. The inner recovery container 322 may have a circular ring shape to surround the spin head 340, and the outer recovery container 326 may have a circular ring shape to surround the inner recovery container 322. An inner space 322a of the inner recovery container 322 and a space 326a between the inner recovery container 322 and the outer recovery container 326 may function as inflow inlets through which fluids flow in the inner recovery container 322 and the outer recovery container 326, respectively. The inner recovery container 322 and the outer recovery container 326 may be connected with recovery lines 322b and 326b vertically extending in a downward direction. The recovery lines 322b and 326b may discharge fluids flowing in through the inner recovery container 322 and the outer recovery container 326. The discharged fluids may be reused through an external fluid recycle system (not shown).

The spin head 340 may support the substrate W during a process and rotate the substrate W. The spin head 340 may include a body 342, a support pin 344, a chuck pin 346, and a support shaft 348. The body 342 may have an upper surface provided in a circular shape when viewed from an upper side. The support shaft 348 rotated by a motor 349 may be fixed to a bottom surface of the body 342.

The support pin 344 may be provided in plurality. The support pins 344 may be disposed at an edge of an upper surface of the body 342 to be spaced apart from each other and protrude from a top surface of the body 342. The support pins 344 may be disposed to form a circular ring shape. The support pins 344 may support an edge of a back surface of the substrate W such that the substrate W is spaced apart from the top surface of the body 342.

The chuck pin 346 may be provided in plurality. The chuck pins 346 may be disposed farther away from a center of the body 342 than the support pins 344. The chuck pins 346 may be provided to protrude from a top surface of the body 342. When the spin head 340 rotates, the chuck pins 346 may support a lateral portion of the substrate W such that the substrate W does not deviate from a given position in a lateral direction. The chuck pins 346 may be disposed to be rectilinearly moved between a standby position and a support position according to a radius direction. The standby position may be farther away from a center of the body 342 than the support position. The chuck pins 346 may be placed at the standby position when the substrate W is loaded or unloaded and at the support position when the substrate W is processed. At the support position, the chuck pins 346 may contact with a lateral portion of the substrate W.

The elevation unit 360 may rectilinearly transfer the housing 320 in an up-and-down direction. As the housing 320 is transferred in an up-and-down direction, a relative height of the housing to the spin head 340 may vary. The elevation unit 360 may include a bracket 362, an elevation shaft 364, and a driver 366. The bracket 362 may be fixed to an outer wall of the housing 320. The elevation shaft 364 may be moved in an up-and-down direction by the driver 366, and may be fixed to the bracket 362. When the substrate W is seated on the spin head 340 or picked up from the spin head 340, the housing 320 may descend so that the spin head 340 protrudes from a top of the housing 320. A height of the housing 320 may be adjusted so that a fluid flows in a predetermined recovery container according to a sort of fluid supplied to the substrate W during a process. Selectively, the elevation unit 360 may move the spin head 340 in an up-and-down direction. The spray unit 380 may spray a first fluid and a second fluid on the substrate W.

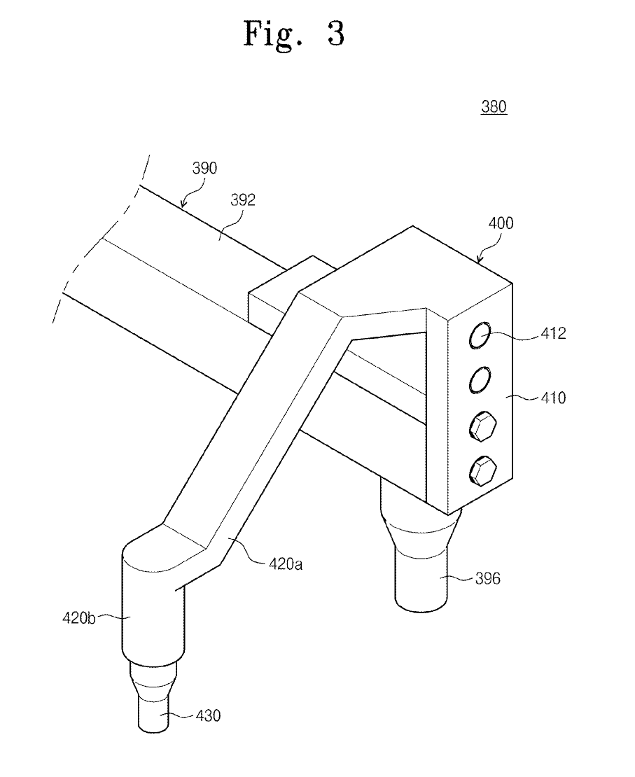

FIG. 3 is a perspective view of a spray unit of FIG. 2 according to an embodiment of the inventive concept. Referring to FIG. 3, a spray unit 380 may include a nozzle support member 390, a first nozzle 396, a second nozzle 430, a height adjusting member 400, and a controller 490.

The nozzle support member 390 may include a vertical shaft 386 and a support bar 392. The vertical shaft 386 may be disposed at one side of a housing 320 outside the housing 320. The vertical shaft 386 may have a load shape, and may be disposed so that its length direction is provided in an up-and-down direction. The vertical shaft 386 may be rotated and elevated by a driver 388.

The support bar 392 may support the first and second nozzles 396 and 430. The support bar 392 may have a load shape. The support bar 392 may be extended from the vertical shaft 386 in a lateral direction. The first nozzle 396 may be fixed to an end of a bottom surface of the support bar 392.

The first nozzle 396 may be moved between a process position and a standby position by rotation of the vertical shaft 386. The process position may be a position where the first nozzle 396 is disposed on a vertical top of a housing 320, and the standby position may be a position where the first nozzle 396 is disposed outside the housing 320.

The first nozzle 396 may spray a first fluid in a mist way. The first fluid sprayed in the mist way may reduce an adhesive force of contaminants and particles attached on a substrate W.

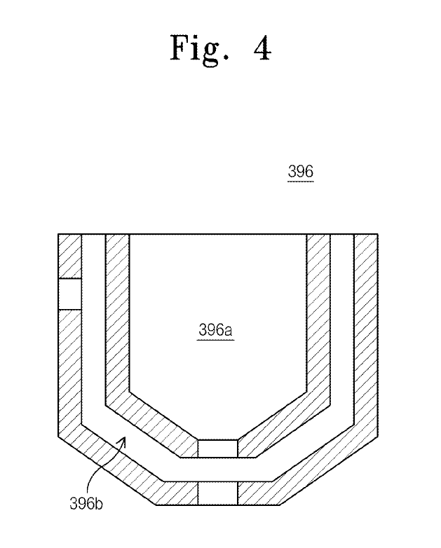

FIG. 4 is a sectional view of a first nozzle of FIG. 3 according to an embodiment of the inventive concept. Referring to FIG. 4, a first nozzle 396 may spray a first fluid in a two-fluid way. The first nozzle 396 may be connected with a first fluid line 462 and a gas line 466. A first path 396a may be provided within an inner center portion of the first nozzle 396. The first path 396a may be supplied with the first fluid from the first fluid line 462. A second path 396b may be provided at an inner edge portion of the first nozzle 396. The second path 396b may have a ring shape to surround the first path 396a. The second path 396b may be supplied with a gas from the gas line 466. A gas flow adjusting member 472 may be provided at the gas line 466 to adjust a flow of gas. Discharge holes formed at a lower area of the second path 396b, a lower area of the first path 396a, and a lower surface of the first nozzle 396 may be interconnected. If the first fluid and a gas are supplied within the first nozzle 396, the first nozzle 396 may mistily spray the first fluid by a gas pressure. A mist size may be adjusted according to a flow of the gas supplied to the first nozzle 396. Unlike this, the gas can be supplied to a fluid sprayed from the first nozzle 396 at a position adjacent to a discharge hole of the first nozzle 396 of an outer portion of the first nozzle 396. The gas may be an inert gas such as a nitrogen gas. The gas flow adjusting member 472 may be formed of a pressure gas member.

In example embodiments, the second nozzle 430 may spray a second fluid in a dropping way.

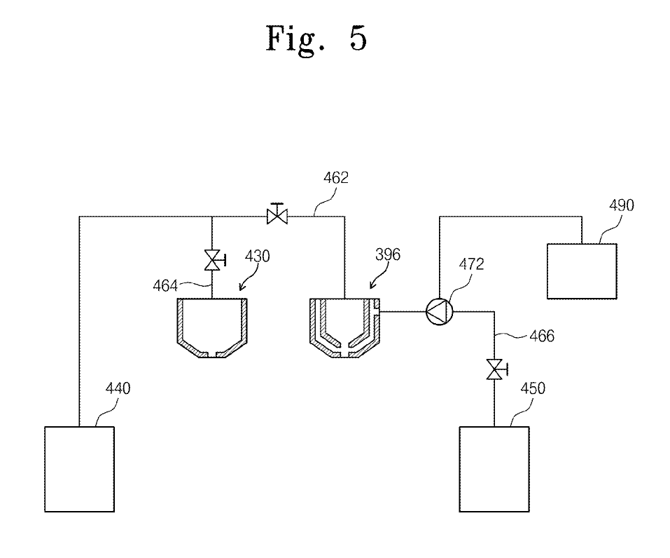

FIG. 5 is a diagram schematically illustrating lines for supplying fluids to a first nozzle 396 and a second nozzle 430. Referring to FIG. 5, a second nozzle 430 may be connected with a second fluid line 464. The second nozzle 430 may be supplied with a second fluid from the second fluid line 464. The second nozzle 430 may be disposed at one side of a first nozzle 396. In example embodiments, the second nozzle 430 may be disposed to be rotated along the same trace as the first nozzle 396 when rotated by a vertical shaft 386. The second nozzle 430 may be controlled to follow a rear portion of the first nozzle 396. A first fluid and a second fluid may be the same sort of different fluids. A first fluid line 462 and the second fluid line 464 may be connected with a first fluid storage unit 440. For example, the first and second fluids may be chemical such as hydrofluoric acid, deionized water, or an organic solvent such as isopropyl alcohol. The second fluid line 464 may be branched from the first fluid line 462.

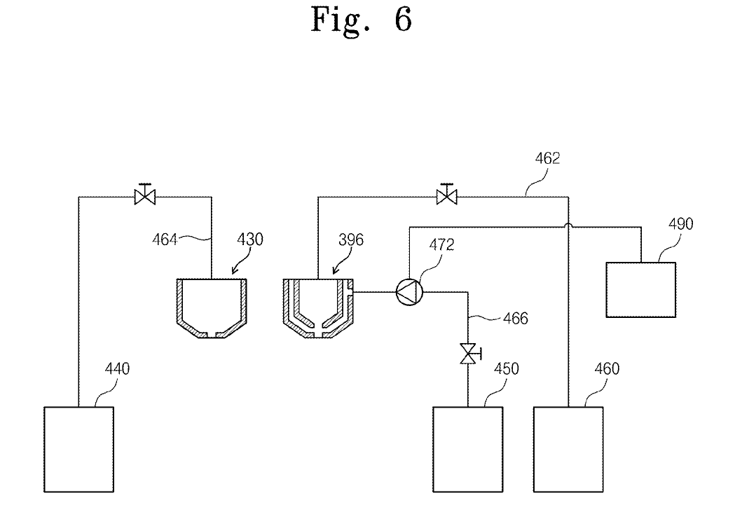

Selectively, as illustrated in FIG. 6, the first fluid line 462 may be connected with the first fluid storage unit 440, and the second fluid line 464 may be connected with a second fluid storage unit 460. In this case, the first and second fluids may be the same sort of fluids or different fluids.

In the above-described embodiment, if the first and second nozzles 396 and 430 spray the same fluid in different ways, the first nozzle 396 spraying the first fluid in a mist way may first supply the first fluid on a specific area of a substrate W, and then the second nozzle 430 spraying the second fluid in a dropping way may supply the second fluid on the specific area of the substrate W.

A height adjusting member 400 may adjust a height of the second nozzle 430 so that a relative height between the first nozzle 396 and the second nozzle 430 is adjusted. In example embodiments, the height adjusting member 400 may adjust heights of the first and second nozzles 396 and 430 so that a first area A on which the first fluid is sprayed is not overlapped with a second area B on which the second fluid is sprayed. Also, the amount of the second fluid spattered from the substrate W may be minimized by adjusting a height of the second nozzle 430. Returning to FIG. 3, the height adjusting member 400 may include a clamping unit 410 and a support unit 420. The clamping unit 410 may be coupled to an end of a support bar 392 to be moved in an up-and-down direction with respect to the support bar 392. The clamping unit 410 may have a bar shape so that its length direction is provided in an up-and-down direction. A plurality of clamping holes 412 may be formed at the clamping unit 410 along a length direction thereof. The clamping holes 412 may be spaced apart from each other. The clamping unit 410 may be screwed to the support bard 392 through the clamping hole 412. For example, a screw may be inserted in at least one of the clamping holes 412 of the champing unit 410. The champing unit 410 may be moved in an up-and-down direction with respect to the support bar 392 according to a position of the clamping hole 412 in which a screw is inserted.

The support unit 420 may be extended from the clamping unit 410. In example embodiments, the support unit 420 may be extended from a top surface of the clamping unit 410. The support unit 420 may have a front area 420a extended from the clamping unit 410 and a rear area 420b extended from the front area 420a. A height of the front area 420a may be higher than that of the rear area 420b. The front area 420a may be provided so that its length direction is mostly inclined downwards. The front area 420a may have a length enabling a horizontal distance between the first nozzle 396 and the second nozzle 430 to be sufficiently spaced apart from each other. For example, the front area 420a may have a length making the first and second areas A and B not overlapped. The rear area 420b may be extended from a bottom of the front area 420a. The second nozzle 430 may be fixed to an end of the rear area 420b.

The controller 490 may control the gas flow adjusting member 472. The controller 490 may adjust a flow of gas supplied to a gas line 466. A mist size of the first fluid may be varied according to a flow of gas adjusted. For example, as a flow of gas sprayed to the first fluid increases, an inner pressure of the first nozzle 396 may increase. In this case, a mist size of the first fluid may decrease. Thus, a cleaning force of the substrate W may be improved. This may mean that a cleaning efficiency for reducing an adhesive force of contaminants and particles is bettered. On the other hand, as a flow of gas sprayed to the first fluid decreases, an inner pressure of the first nozzle 396 may decrease. In this case, a mist size of the first fluid may increase. If the mist size increases, an effect of lowering an adhesive force on contaminants and particles may be relatively reduced. In this case, like a dropping way, an effect of removing contaminants and particles on the substrate W the adhesive force of which is reduced may be improved.

There is described an example in which the first nozzle 396 mistily sprays the first fluid in the two-fluid way and the second nozzle 430 sprays the second fluid in the dropping way.

On the other hand, the first and second nozzles 396 and 430 may mistily spray a fluid.

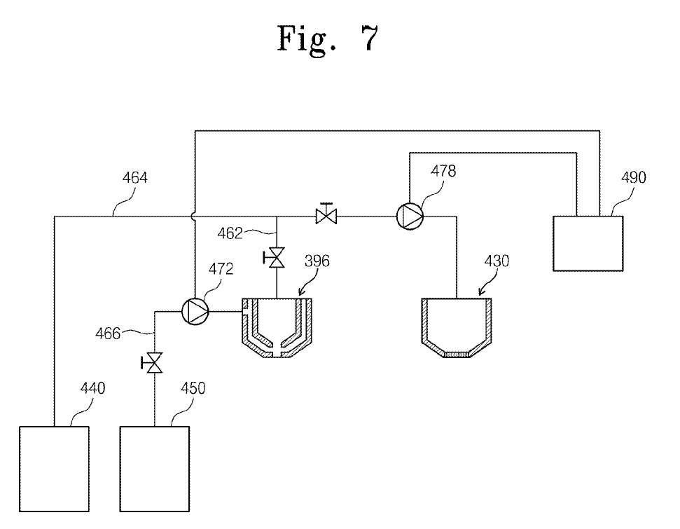

FIG. 7 is a view of a spray unit of FIG. 2 according to another embodiment of the inventive concept. In example embodiments, a first nozzle 396 and a second nozzle 430 may mistily spray a fluid in different ways. The first nozzle 396 may spray a mist in a two-fluid way, and the second nozzle 430 may spray a mist in a minute discharge hole way. The second nozzle 430 may be connected to a second fluid line 464. The second nozzle 430 may be supplied with a second fluid from the second fluid line 464. A fluid flow adjusting member 474 may be installed at the second fluid line 464.

The fluid flow adjusting member 474 may adjust a discharge flow of the second fluid by pressurizing an inside of the second fluid line 464. A plurality of discharge holes for discharging the second fluid may be formed at a bottom surface of the second nozzle 430. A mist size may be adjusted according to a size of a discharge hole. The controller 490 may control the fluid flow adjusting member 474 and the gas flow adjusting member 472. The controller 490 may control the fluid flow adjusting member 474 to adjust a pressure of an inside of the second fluid line 464. A size of mist sprayed from the second nozzle 430 may vary according to the pressure. For example, if a fluid supply pressure increases, a mist size of the fluid may decrease. In this case, a cleaning force of the substrate W may be improved. This may mean that a cleaning efficiency for reducing an adhesive force of contaminants and particles is bettered. On the other hand, as an inner pressure of the first nozzle 396 decreases, a mist size of the first fluid may increase. If the mist size increases, an effect of removing contaminants and particles on the substrate W the adhesive force of which is reduced may be improved. For example, the fluid flow adjusting member 474 may be a pressure member such as a pump. The constitution of adjusting a flow and a size of mist using the gas flow adjusting member 472 may be substantially the same as described above, and a description thereof is thus omitted.

The first and second nozzles 396 and 430 may be provided to spray a fluid in a two-fluid way.

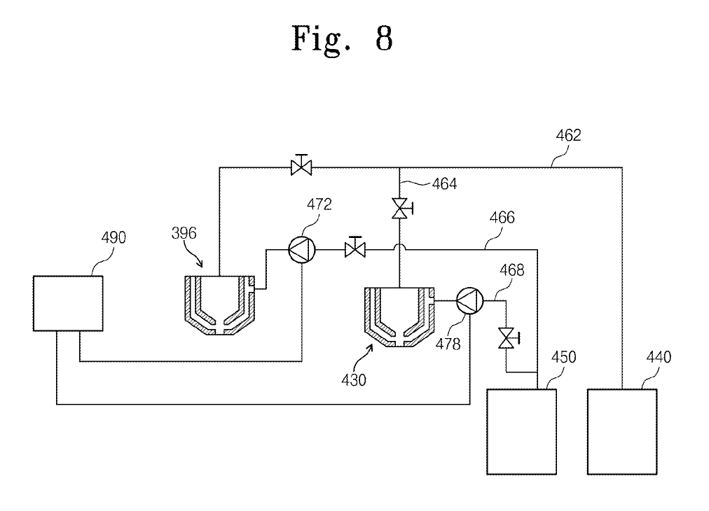

FIG. 8 is a perspective view of a spray unit of FIG. 2 according to still another embodiment of the inventive concept. Referring to FIG. 8, a first fluid line 462 and a first gas line 466 may be connected with a first nozzle 396. A first gas flow adjusting member 472 may be installed at a first gas line 466, and may adjust a flow of a first gas. The second nozzle 430 may be connected with a second fluid line 464 and a second gas line 466. A second gas flow adjusting member 474 may be installed at the second gas line 466, and may adjust a flow of a second gas. A controller 490 may control the first gas flow adjusting member 472 and the second gas flow adjusting member 474 so that mist sprayed from the first nozzle 396 is different in size from that sprayed from the second nozzle 430.

The first nozzle 396 and the second nozzle 430 may be provided to spray a fluid in a minute discharge hole way.

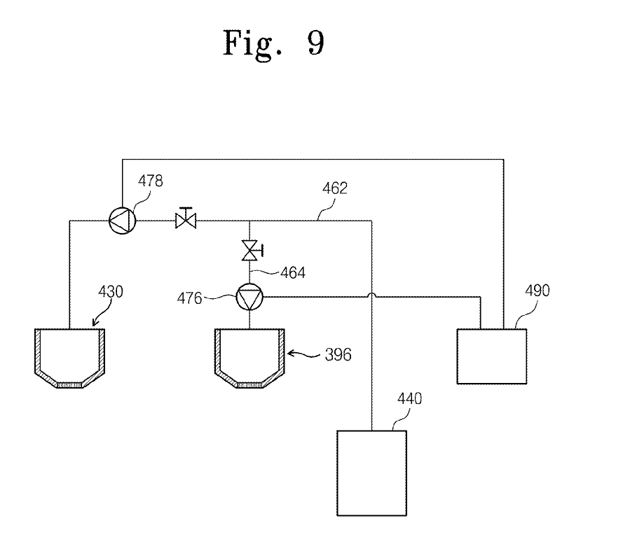

FIG. 9 is a perspective view of a spray unit of FIG. 2 according to still another embodiment of the inventive concept. A first nozzle 396 may be connected with a first fluid line 462, and a first fluid flow adjusting member 476 may be installed at the first fluid line 462. A second nozzle 430 may be connected to a second fluid line 464, and a second fluid flow adjusting member 478 may be installed at the second fluid line 464. A controller 490 may control the first fluid flow adjusting member 476 and the second fluid flow adjusting member 478 so that a flow of mist sprayed from the first nozzle 396 is different from that sprayed from the second nozzle 430.

In example embodiments, in the event that the first nozzle 396 and the second nozzle 430 supply the same fluid to have different mist sizes, a nozzle of spraying small-sized mist may first supply a fluid on a specific area of a substrate W, and then a nozzle of spraying large-sized mist may supply a fluid on the specific area.

Also, the first nozzle 396 and the second nozzle 430 may be placed at different heights. In this case, a cleaning force of the first fluid on the substrate W may be different from that of the second fluid.

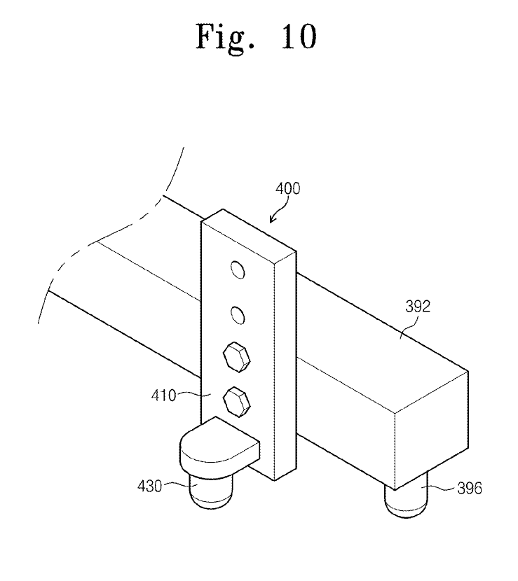

FIG. 10 is a perspective view of a spray unit of FIG. 2 according to still another embodiment of the inventive concept. A height adjusting member 400 may have a clamping unit 410 which is directly coupled to a support bar 392. A second nozzle 430 may be fixed to a bottom portion of the clamping unit 410. The clamping unit 410 may be coupled to one side of the support bar 392 to move in an up-and-down direction relatively with respect to the support bar 392.

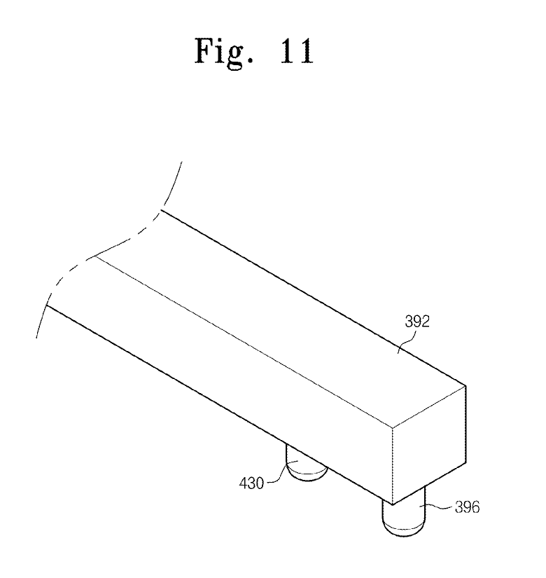

FIG. 11 is a perspective view of a spray unit of FIG. 2 according to still another embodiment of the inventive concept. In a spray unit 380, a first nozzle 396 and a second nozzle 430 may be directly fixed to a support bar 392, respectively.

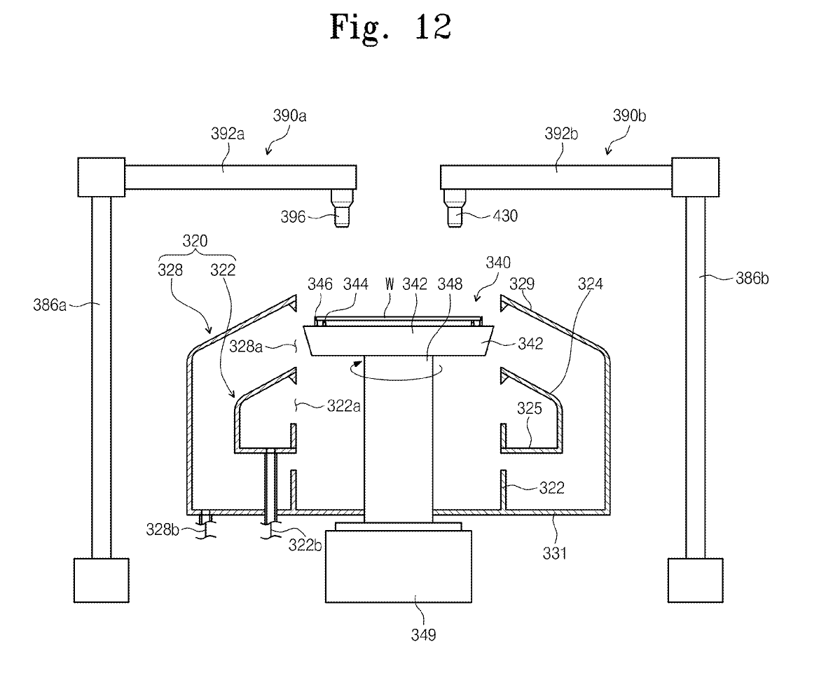

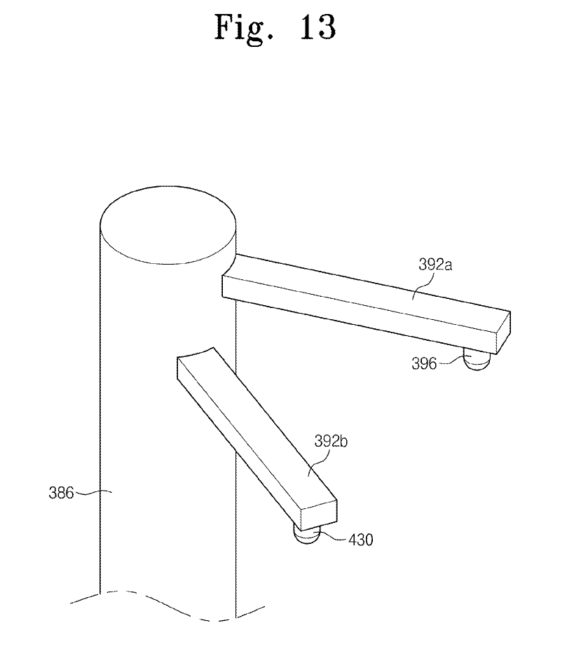

FIG. 12 is a perspective view of a spray unit of FIG. 2 according to still another embodiment of the inventive concept. A spray unit 380 may include a first nozzle support member 390a and a second nozzle support member 390b. The first nozzle support member 390a may support a first nozzle 396, and the second nozzle support member 390b may support a second nozzle 430. The first nozzle support member 390a may include a first vertical shaft 386a and a first support bar 392a. The first vertical shaft 386a may be placed at one side of a housing 320. The second nozzle support member 390b may include a second vertical shaft 386b and a second support bar 392b. The second vertical shaft 386b may be placed at the other side of the housing 320. Each of the first nozzle support member 390a and the second nozzle support member 390b may be substantially the same as the above-described nozzle support member 390, and a detailed description thereof is thus omitted.

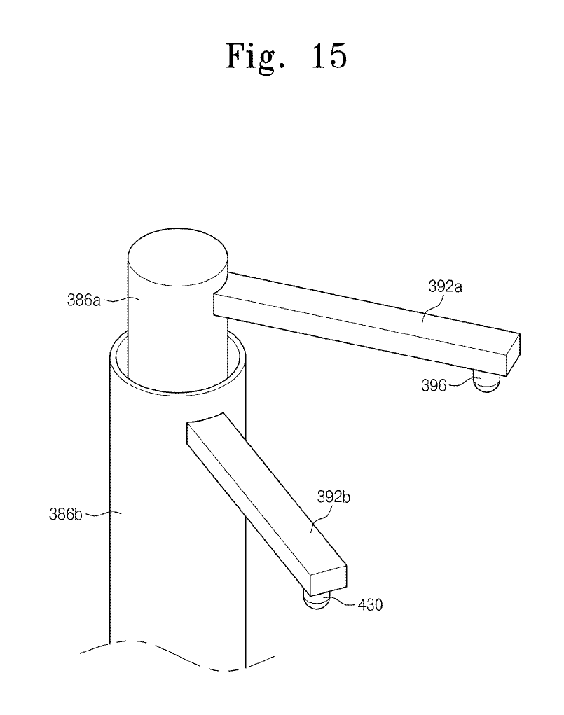

FIG. 15 is a perspective view of a spray unit of FIG. 2 according to still another embodiment of the inventive concept. In a spray unit 380, a nozzle support member 390 may include a vertical shaft 386, a first support bar 392a, and a second support bar 392b. Each of the first and second support bars 392a and 392b may be extended from the vertical shaft 386 in a lateral direction. The first and second support bars 392a and 392b may be placed at different heights. A height of the first support bar 392a may be higher than that of the second support bar 392b. When viewed from an upper side, the first and second support bar 392a and 392b may be disposed so that the first support bar 392a makes an acute angle with the second support bar 392b. Selectively, the first and second support bars 392a and 392b may be placed at the same height.

With the above structure, it is possible to sufficiently secure a gap between the first and second nozzles 396 and 340 when the first and second nozzles 396 and 340 conduct swing movement or straight movement between a center of a substrate W and an edge.

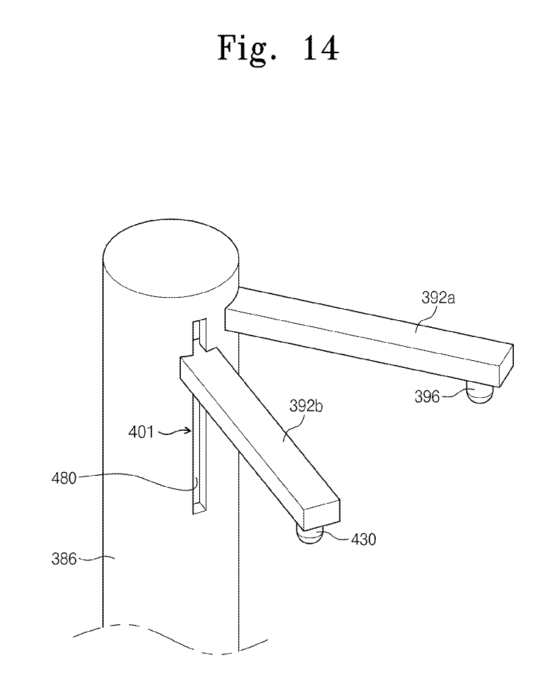

FIG. 14 is a perspective view of a spray unit of FIG. 2 according to still another embodiment of the inventive concept. A height adjusting member 401 may include a guide rail 480 and a motor (not shown). The guide rail 480 may be installed at a lateral portion of a vertical shaft 386. The guide rail 480 may be disposed so that its length direction is provided in an up-and-down direction. One end of a second support bar 392b may be fixed to the guide rail 480. The motor may move the second support bar 392b coupled to the guide rail 480 in an up-and-down direction. Selectively, the height adjusting member 401 may be provided to a clamping unit 410 of a height adjusting member 400 of FIG. 3 so that a worker changes a height of the second support bar 392b through screwing.

FIG. 15 is a perspective view of a spray unit of FIG. 2 according to still another embodiment of the inventive concept. A vertical shaft 386 of a nozzle support member 390 may include an outer shaft 386b and an inner shaft 386a. The outer shaft 386b may have a ring shape to surround the inner shaft 386a. An upper area of the inner shaft 386a may protrude from the outer shaft 386b. A first support bar 392a may be extended in a lateral direction on an upper area of the inner shaft 386a, and a first nozzle 396 may be disposed at an end of the first support bar 392a. A second support bar 392b may be extended from the outer shaft 386b in a lateral direction. A second nozzle 430 may be disposed at an end of the second support bar 392b. The outer shaft 386b and the inner shaft 386a may be independently operated.

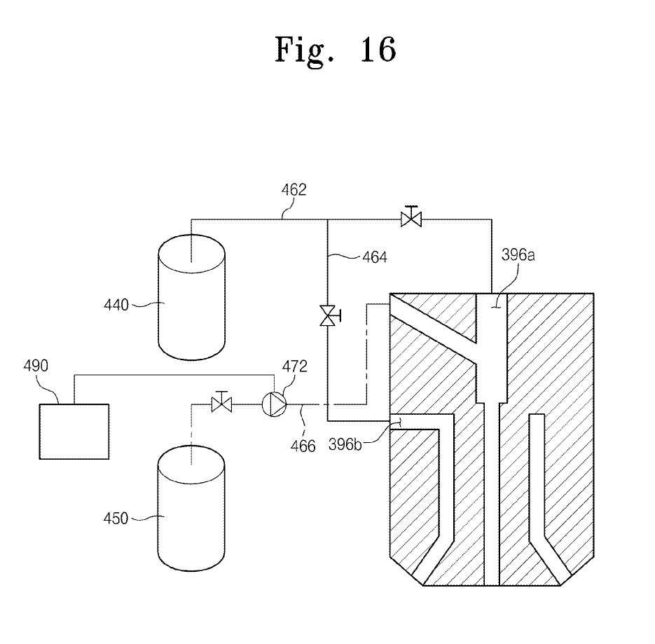

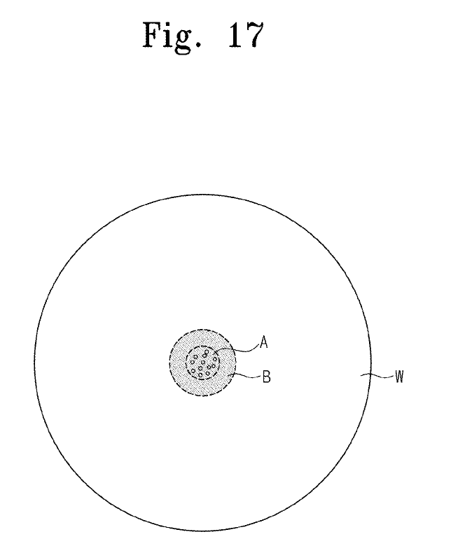

FIG. 16 is a perspective view of a spray unit of FIG. 2 according to still another embodiment of the inventive concept. A first nozzle 396 and a second nozzle 430 may be integrated in a body. A second path 396b of the second nozzle 430 may surround a first path 3396a of a first nozzle 396. The second path 396b of the second nozzle 430 may have a ring shape. A first fluid line 462 and a gas line 466 may be connected with the first path 396a. The first fluid line 462 may supply a first fluid to the first path 396a, and the gas line 466 may supply a gas to the first path 396a. A second fluid line 464 may be connected with the second path 396b. The second fluid line 464 may supply a second fluid to the second path 396b. In this case, as illustrated in FIG. 17, a first area A of a substrate W on which the first fluid is sprayed may have a circular shape, and a second area B of the substrate W on which the second fluid is sprayed may have a ring shape.

With the above description, the same sort of fluid may be sprayed in different ways, by different sizes of mist, or at different heights. In this case, a cleaning efficiency may be improved in comparison with such a case that a fluid is sprayed in a specific spray way, by a specific size of mist, and at a specific height.

There is described an example in which the first nozzle 396 and the second nozzle 430 spray a fluid at the same time. However, a cleaning process may be performed using a nozzle according to a sort of substrate W and a material layer formed on the substrate W.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A substrate treating apparatus comprising:
a housing which provides a space in which a process is performed;
a spin head which supports and rotates a substrate; and
a spray unit which sprays a fluid on the substrate,
wherein the spray unit comprises:
a first nozzle mistily spraying a first fluid; and
a second nozzle spraying a second fluid.

2. The substrate treating apparatus of claim 1, wherein the first nozzle sprays the first fluid in a two-fluid way.

3. The substrate treating apparatus of claim 1, wherein the first nozzle sprays the first fluid in a minute discharge hole way.

4. The substrate treating apparatus of claim 1, wherein the second nozzle mistily sprays the second fluid.

5. The substrate treating apparatus of claim 4, wherein the first nozzle and the second nozzle spray a fluid in a two-fluid way.

6. The substrate treating apparatus of claim 5, wherein the spray unit further comprises:
a first gas line which supplies a gas to the first nozzle and has a first flow adjusting member;
a second gas line which supplies a gas to the second nozzle and has a second flow adjusting member; and
a controller which controls the first flow adjusting member and the second flow adjusting member, and
wherein the controller controls the first flow adjusting member and the second flow adjusting member so that a size of mist sprayed from the first nozzle is different from that of mist sprayed from the second nozzle.

7. The substrate treating apparatus of claim 4, wherein the first nozzle and the second nozzle spray a fluid in a minute discharge hole way.

8. The substrate treating apparatus of claim 7, wherein a size of a discharge hole of the first nozzle is different from that of the second nozzle so that a size of mist sprayed from the first nozzle is different from that of mist sprayed from the second nozzle.

9. The substrate treating apparatus of claim 7, further comprising:
a first flow adjusting member which adjust a flow of the first fluid;
a second flow adjusting member which adjust a flow of the second fluid; and
a controller which controls the first flow adjusting member and the second flow adjusting member, and
wherein the controller controls the first flow adjusting member and the second flow adjusting member so that a size of mist sprayed from the first nozzle is different from that of mist sprayed from the second nozzle.

10. The substrate treating apparatus of claim 4, wherein one of the first nozzle and the second nozzle sprays a fluid in a two-fluid way and the other sprays a fluid in a minute discharge hole way.

11. The substrate treating apparatus of claim 1, wherein the second nozzle sprays the second fluid in a dropping way.

12. The substrate treating apparatus of claim 1, further comprising:
a nozzle support member which supports the first nozzle and the second nozzle, and
wherein the nozzle support member comprises:
a vertical shaft the length direction of which is provided in an up-and-down way; and
a support bar which is extended from the vertical shaft in a lateral direction and is coupled with the first nozzle and the second nozzle.

13. The substrate treating apparatus of claim 12, wherein the nozzle support member further comprises:
a height adjusting member which adjusts relative heights of the first nozzle and the second nozzle.

14. The substrate treating apparatus of claim 1, further comprising:
a first nozzle support member which supports the first nozzle; and
a second nozzle support member which supports the second nozzle,
wherein the first nozzle support member comprises:
a first vertical shaft the length direction of which is provided in an up-and-down direction; and
a first support bar which is extended from the first vertical shaft and is coupled with the first nozzle, and
wherein the second nozzle support member comprises:
a second vertical shaft the length direction of which is provided in an up-and-down direction; and
a second support bar which is extended from the second vertical shaft and is coupled with the second nozzle.

15. The substrate treating apparatus of claim 1, further comprising:
a nozzle support member which supports the first nozzle and the second nozzle,
wherein the nozzle support member comprises:
a vertical shaft the length direction of which is provided in an up-and-down direction;
a first support bar which is extended from the vertical shaft and is coupled with the first nozzle; and
a second support bar which is extended from the vertical shaft and is coupled with the second nozzle, and
wherein the first support bar makes an acute angle with the second support bar when viewed from an upper side.

16. The substrate treating apparatus of claim 15, wherein the spray unit further comprises:
a rotation driver which rotates the vertical shaft with an up-and-down direction as the center.

17. The substrate treating apparatus of claim 15, wherein a height of the first support bar is different from a height of the second support bar.

18. The substrate treating apparatus of claim 15, further comprising:
a height adjusting member which adjusts relative heights of the first and second support bars.

19. The substrate treating apparatus of claim 1, wherein a first path for supplying the first fluid is provided within the first nozzle and a second path is provided within the second nozzle, one of the first and second paths surrounding the other.

20. The substrate treating apparatus of claim 1, wherein the spray unit further comprises:
a first fluid line which supplies the first fluid to the first nozzle; and
a second fluid line which supplies the second fluid to the second nozzle, the second fluid line being branched from the first fluid line.

21. A method of treating a substrate using a first nozzle and a second nozzle, the first nozzle spraying a first fluid on the substrate, the second nozzle spraying a second fluid on the substrate, and the first nozzle mistily spraying the first fluid.

22. The method of claim 21, wherein the second nozzle mistily sprays the second fluid and the first nozzle and the second nozzle spray a fluid in a two-fluid way.

23. The method of claim 21, wherein the second nozzle mistily sprays the second fluid and the first nozzle and the second nozzle spray a fluid in a minute discharge hole way.

24. The method of claim 21, wherein the second nozzle mistily sprays the second fluid and the first nozzle, one of the first and second nozzles sprays a fluid in a two-fluid way, and the other sprays a fluid in a minute discharge hole way.

25. The method of claim 21, wherein the first and second fluids are the same fluid.

26. The method of claim 21, wherein relative heights of the first and second nozzles are adjusted so that a first area of the substrate on which the first fluid is supplied and a second area of the substrate on which the second fluid is supplied have different from each other.
